(19) United States
(12) Patent Application Publication
(10) Pub. No.: US 2010/0101677 A1
(43) Pub. Date: Apr. 29, 2010

(54) COVERING DEVICE

(75) Inventors: Volker Liebel, Erlangen (DE); Anja Bolli, Lenzerheide (CH); Roberto Rudi, Schinznach-Dorf (CH)

Correspondence Address: MCCORMICK, PAULDING & HUBER LLP, CITY PLACE II, 185 ASYLUM STREET, HARTFORD, CT, 06103, US

(73) Assignee: Rehau AG & Co., Rehau (DE)

(21) Appl. No.: 12/377,281

(22) PCT Filed: Aug. 8, 2007
(86) PCT No.: PCT/EP07/07011

§ 371 Date: Mar. 27, 2009

(30) Foreign Application Priority Data
Aug. 12, 2006 (EP) 06115127.0

(51) Int. Cl. F16L 59/00

(52) U.S. Cl. 138/158; 138/162; 138/149; 138/165; 138/168

(57) ABSTRACT

The invention relates to a covering device, preferably for post-isolating the connection point of pipes, in particular district heating pipes. Said device comprises at least two cover shells (1, 2) which surround the pipes in the mounted state, and at least one connection means (3) for connecting the cover shells (1,2). The connection means (3) comprise at least one substantially hook-shaped engaging section (4) that is provided for a positive fit connection, at least in parts, having at least one maintaining section (5) enabling the covering shells to be braced against one another. A sealing element (14) is arranged between the covering device and a pipe, in the mounted state, and surrounds the pipe.

The present invention concerns a covering device, preferably for the subsequent insulating of the connection location of pipes, especially trunk heating pipes, including at least two cover shells, which shells in assembled condition surround the pipes, and at least one connector means for connecting the cover shells.

Trunk heating pipes consist of at least one medium pipe, a heat insulation arranged on the pipe, and an outer jacket surrounding the heat insulation. When trunk heating pipes have to be connected, for example to create a branch line, at the ends of the pipes to be joined the outer jacket as well as the heat insulation has to be removed to expose the medium pipe. Only then is a connection of the medium pipes possible. After the medium pipes have been connected it is then finally necessary to re-establish the heat insulation at the connection location.

For solving this problem a covering device is known from DE 4 226 914 C which consists of two shaped halves, with the shaped halves being connectable to one another by means of nuts and bolts. The sealing in this case is accomplished with the help of a quantity of butyl sealing material. A disadvantage of this device is the expensive and very time-consuming assembly of the large number of nuts and bolts.

The object of the invention is therefore to provide a covering device which at least avoids the stated disadvantage of the state of the art.

This object is solved in accordance with the invention by a covering device of the previously mentioned kind which in comparison to the generic covering device is improved in that the connector means includes an engagement section, which engagement section provides for at least one section-wise form fit locking closure connection with at least one holding section so that the cover shells can be tightened against one another.

It has been demonstrated that with the help of the described connector means in a fast, effective and simple way a reliable and secure connection between the cover shells can be made.

It can be of advantage that the engagement section is made to be of hook shape. By doing this an especially secure connection is achieved.

Likewise it can be of advantage that the connector means is made integral with one of the two cover shells. This provides an easier assembly, and the danger of parts necessary for the assembly becoming lost is significantly reduced. It is also conceivable that the cover shells and the connector means are so implemented that the connector means has a snap fit into a corresponding receiving element of the cover shells.

It can furthermore be of advantage that the connector means is made as a clip with two engagement sections lying oppositely to one another. This is an especially simple embodiment which can be easily made at low construction expense and which provides a very reliable type of connection.

It can moreover be of advantage to have the connector means formed as a lever closure, preferably as a toggle lever closure. This provides and extremely strong tightening of the cover shells to one another.

Still further it can be of advantage to have the holding section integral with the covering device. This is of advantage on the basis of manufacturing techniques. It can also prove beneficial to have the holding section made integral with a tension element encircling the cover shells in assembled condition. This provides a high degree of freedom in respect to the shape of the cover shells, and without having to take into special consideration the arrangement of the connecting means.

Likewise it can also prove to be beneficial for the cover shells to have stiffening ribs formed integral with themselves. In this way, a very high stiffness of the cover shells or covering device is achieved simultaneously with using only a small amount of material.

Also it can prove to be beneficial to have arranged between the engagement surfaces of the cover shells in assembled condition at least section-wise sealing element, preferably a plastic sealing mass or an elastomeric shaped seal. This provides a sealing of the cover shells relative to one another so that for example no wetness can penetrate into the covering device.

It furthermore can prove to be advantageous in that the engagement surfaces are so shaped that in the assembled condition of the cover shells a tongue and groove connection is achieved. This results in a very sealingly tight and reliable connection of the cover shells, so that depending on the degree of sealing tightness of the covering device required, a sealing element might be abandoned. In the case of a mirror image formation of the tongue and groove connection, the two cover shells can be made from the same work tooling.

It can further prove to be advantageous that the cover shells and/or the connector means and/or the tension element be made of a polymer material, preferably a thermoplasticly processable plastic material. These materials are similarly advantageous and in the case of complicated geometries allow themselves to be simply and economically processed.

The invention concerns moreover a covering device, preferably for the subsequent insulation of the connecting location of pipes, including at least two cover shells, which shells in assembled condition surround the pipes, with the covering device further including at least one sealing element that in assembled condition is arranged between the covering device and a pipe and surrounds the pipe.

It has been shown that in this way a simple and effective type of sealing of the pipe relative to the covering device is achieved.

In this case, it can be of advantage that the sealing element is implemented as a sealing ring. This geometry permits a relatively simple realization of the sealing element.

It can moreover be of advantage that the sealing element at least one point along its circumference is totally separated. Especially in the case of the sealing element being a sealing ring the sealing ring can be made of two parts or can be made to swing open.

In this way it is possible that after the making of the pipe connection and before the assembly of the cover shells the sealing element can be mounted onto a pipe.

Likewise it can be of advantage that the sealing element have at least one weakened breakage point. This allows the sealing element to be easily broken at that point so that the element can be mounted onto the pipe even after the making of the pipe connection, in case the mounting of the sealing element prior to the making of the pipe connection has been forgotten.

Moreover, it can be of advantage that the sealing element has at least two concentric rings. Thereby, the mating of the sealing element to different pipe diameters is possible by the removal of individual rings.

It can also prove advantageous that the sealing element has rib-shaped projections on its inner wall and/or its outer wall. In this way a good sealing effect itself is achieved with reduced pressure forces.

Further it can be advantageous that the sealing element in its assembled condition is shape wise positively connected with the cover shells. This guarantees a secure and reliable positioning of the sealing element.

It can also be of advantage that the sealing element be made of a polymer material, preferably from an elastomer or a thermal plastic elastomer. These materials because of their elastic properties are especially well suited for use as the sealing element.

All combinations of the previously described preferred embodiments are likewise possible.

The features and advantages of the invention are together set forth in the following description with reference being made to the accompanying drawings in which the following is illustrated:

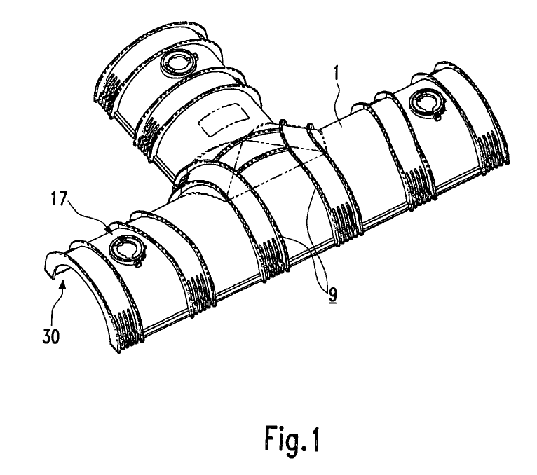

FIG. 1: A three dimensional illustration of a cover shell of a covering device embodying the invention;

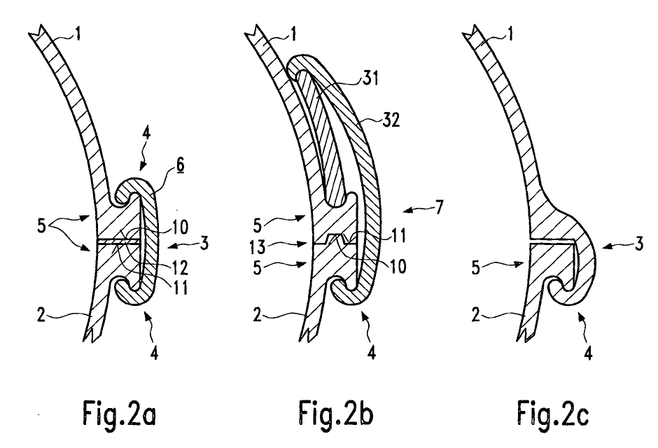

FIG. 2a: A sectional view of a first embodiment according to the invention of a connector means in assembled condition;

FIG. 2b: A sectional view of a second embodiment according to the invention of a connector means in assembled condition;

FIG. 2c: A sectional view of a third embodiment according to the invention of a connector means;

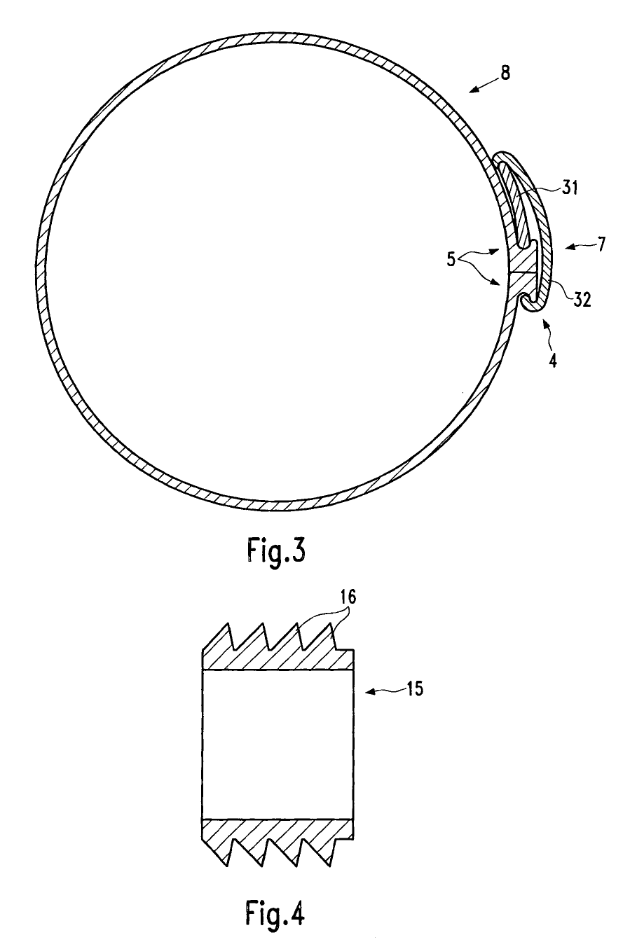

FIG. 3: A sectional view of a connector means in accordance with the invention in combination with a tension element in assembled condition; and

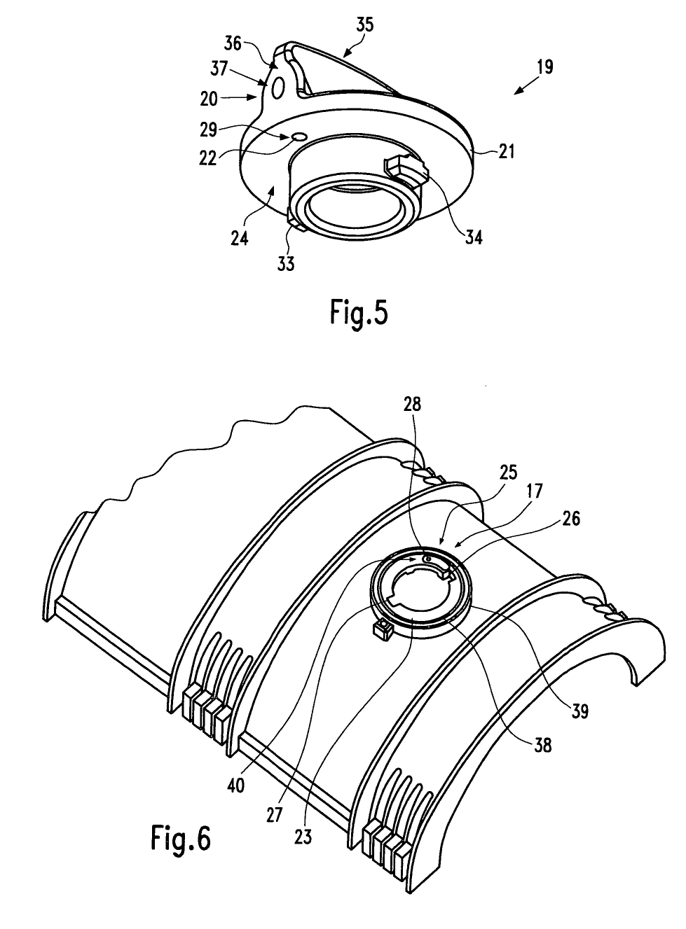

FIG. 4: A sectional view of a sealing element in accordance with the invention;

FIG. 1 shows a three-dimensional representation of a cover shell 1 of a covering device in accordance with the invention. The cover shell 1 is designed as a half shell with a T-shape for the covering of a corresponding 90° branch, but it is conceivable that the cover shell could be made with a cross shape for the covering of two oppositely directed 90° branches. It is also conceivable that the cover shell 1 could be made as a straight or curved piece for the covering of a straight or curved connecting section. The cover shell 1 is made of polypropylene and is made by an injection molding process; with other plastics such as PE, ABS etc. and other manufacturing processes, for example, pressing, being substitutable. The cover shell 1 has a number of stiffening ribs 9 formed integral with itself. Furthermore, the cover shell has three inlet openings 17 each of which is arranged in the region of the summit of the half shell. Further each of the three inlet openings 17 is arranged in the region of an associated one of the end sections of the cover shell 1. Outwardly from each inlet opening the cover shell 1 has a sealing element receiving section 30 for securely positioning onto it the (not illustrated) sealing element 14.

FIG. 2a shows a first embodiment of a connector means in accordance with the invention in assembled condition and in cross section. The connecting means 3 is realized as a one piece clip 6 with two hook shaped oppositely lying engagement sections 4. One engagement section 4 is arranged in engagement with the holding section 5 of the upper cover shell 1, and the other, oppositely lying, engagement section 4 is located in engagement with the holding section 5 of the lower cover shell 2, with each of the holding sections 5 being formed integral with its corresponding cover shell. Between the engagement surfaces 10, 11 of the upper cover shell 1 and of the lower cover shell 2 is arranged an elastomeric seal 12.

FIG. 2b shows in cross section a second embodiment of a connector means in accordance with the invention in assembled condition. This case concerns the use of a toggle lever closure 7 with two toggle lever elements 31, 32. The toggle lever element 31 engages the holding section 5 formed integral with the upper cover shell 1, while the toggle lever element 32 engages with its hook shaped engagement section 4 the holding section 5 formed integral with the lower cover shell 2. The engagement surfaces 10, 11 of the upper cover shell 1 and of the lower cover shell 2 are so designed that when the two cover shells 1, 2 are moved together or put into assembled condition, a tongue and groove connection 13 is formed.

FIG. 2c in cross section shows a third embodiment of a connector means in accordance with the invention. The connector means 3 is formed integral with the upper cover shell 1 and is by way of its hook shaped engagement section 4 put into engagement with the holding section 5 formed integrally on the lower cover shell 2.

FIG. 3 shows a connector means embodying the invention together with a tension element in assembled condition. The tension element 8 for completely surrounding or embracing the moved together or assembled cover shells 1, 2 (not illustrated) has formed integrally with it two holding sections 5, with the toggle lever element 31 of the toggle lever closure 7 being in engagement with the upper holding section 5, while the toggle lever element 32 with its claw shaped engagement section 4 engages the lower holding section 5 as seen in the drawing. The tension element 8 is made of a thermoplasticly processable plastic, but other materials are conceivable, such as the group of metallic work materials, or composite work materials, for example those made of plastic and metal.

FIG. 4 shows a sealing element embodying the invention in cross section. Involved here is a sealing ring 15 whose inner wall is smooth and whose outer wall is of ribbed shape, for example of saw toothed shape with projections 16. Other ribbed geometries are likewise possible. The inner diameter of the sealing ring 15 corresponds in general to the outer diameter of the (not illustrated) pipe onto which the sealing ring is to be placed. The sealing ring 15 is made of an elastomeric material.

In the following the effectiveness and functionality of the invention is explained in more detail.

The covering device serves preferably for the subsequent insulating of the connection location of pipes, especially of trunk heating pipes. The state of the art describes as to this, and for example, a device consisting of two shaped halves, with the shaped halves being connected by means of nuts and bolts. The sealing in this case takes place, for example, with the help of a quantity of butyl sealing material. A disadvantage of this state of the art is the fact that the assembly of the numerous nuts and bolts is extremely expensive and time consuming.

The covering device in accordance with the invention on the other hand makes possible a simple, rapid and effective way for overcoming at least the above mentioned disadvantage of the state of the art. In this case, the connector means 3 of the at least two cover shells 1, 2 and of the covering device including at least one connector means 3 has an essentially hook shaped section 4 which is provided for an at least section-wise shape fitting positive connection with at least one holding section 5, so that the cover shells 1, 2 are tightened relative to one another.

In the case of the covering and subsequent insulating of a pipe connection with a right angled branch location T-shaped cover shells 1, 2 are used. Preferably the cover shells 1, 2 are designed as half shells with identical geometries, so that only one tooling is needed for their making. In the assembly of the covering device first one, preferably the lower, cover shell 2 and the sealing element 14, for example in the form of sealing rings 15 already applied to the pipes before the connection of the pipes, are so arranged relative to one another that the corresponding part of each seal ring 15 forms a positive shape fitting connection with its associated sealing element receiving section 30 of the lower cover shell 2.

Preferably at this time a seal 12 in the form of a profiled sealing element or in the form of a sealing mass can be laid onto or applied to the lower shell 2. It is also conceivable that the seal 12 may have been previously applied.

Then the second, upper cover shell 1 is so arranged that the not yet form fittingly connected portion of the sealing ring 15 is made to form a form fitting connection with the associated sealing element receiving section 30 of the upper cover shell 1.

Also a seal 12 can be pre-applied to the upper engagement surface 10 or can be assembled with or applied to the engagement surface 10 during the assembly procedure. In order to now clamp together the two cover shells 1, 2 the connector means 3, for example in a form of clips 6 with oppositely lying hook shaped engagement sections 4, by means of snap fits can be brought into engagement with the holding section 5 of the cover shells 1, 2. This is done preferably at a number of locations of the covering device in order to uniformly distribute the tightening force.

By way of the tightening of the cover shells 1, 2 relative to one another there results a sealingly tight connection which is still further improved by the described use of a seal 12 arranged between the engagement surfaces 10, 11. If the engagement surfaces 10, 11 of the upper and lower cover shells 1, 2 are so designed that when they are brought together for example a tongue and groove connection 13 is obtained, depending on circumstances, a seal 12 arranged between the engagement surfaces 10, 11 can sometimes be abandoned. Further, the tightening of the cover shells 1, 2 serves to cause the sealing rings 15 to be pressed against the interior walls of the cover shells 1, 2 with the result of obtaining a good sealing of the covering device relative to the pipes.

In order now in the assembled and sealed condition of the covering device to realize the subsequent insulation of the pipes, first closure elements 19 are inserted into two of the three inlet openings 17 and are turned until reaching their second detent positions, that is they are snapped into their closed positions so that each of the corresponding inlet openings 17 is closed and so that the closure elements 19 are essentially sealed against the cover shell 1 or against the covering device. In the remaining inlet opening 17, which in general is taken to be the inlet opening which under the given assembly conditions has the highest position, the sealing material is now filled.

Here the sealing material is for example an in-situ expanding material such as a polyurethane foam. Preferably the sealing material is supplied with the help of a cartridge, with the cartridge containing a predetermined amount of sealing material which is suited to the volume of the then existing intermediate space.

After the insertion of the sealing material a closure element is also inserted into the third inlet opening 17.

1. A covering device, preferably for the subsequent insulation of the connection location of pipes, including at least two cover shells (1, 2), which shells in assembled condition surround the pipes, and at least one connector means (3) for connecting the cover shells (1, 2), further characterized in that the connector means (3) has at least one essentially hook shaped engagement section (4) which is provided to achieve an at least section-wise form fitting positive connection with at least one holding section (5) so that the cover sections (1, 2) are tightened against one another.

2. A covering device according to claim 1, further characterized in that the engagement section (4) is of hook shape.

3. A covering device according to claim 1, further characterized in that the connector means (3) is formed to be integral with at least one of the two cover shells (1, 2).

4. A covering device according to claim 1, further characterized in that the connector means is formed as a clip with two hook shaped sections lying oppositely to one another.

5. A covering device according to claim 1, further characterized in that the connector means (3) is formed as a lever closure device, preferably as a toggle closure device (7).

6. A covering device according to claim 1, further characterized in that the holding section (5) is formed integral with the covering device.

7. A covering device according to claim 1, further characterized in that the holding section (5) is formed integral with a tension element (8) which surrounds the cover shells (1, 2) in their assembled condition.

8. A covering device according to claim 1, further characterized in that the cover shells (1, 2) have stiffening ribs (9) integral with the cover shells (1, 2).

9. A covering device according to claim 1, further characterized that a plastic mass of sealing material or an elastomeric profiled sealing element is arranged at least section-wise between the engagement surfaces (10, 11) of the cover shells (1, 2) in their assembled condition.

10. A covering device according to claim 1, further characterized in that the engagement surfaces (10, 11) are so shaped that in the assembled condition of the cover shells (1, 2) a tongue and groove connection (13) is obtained.

11. A covering device according to claim 1, further characterized in that the cover shells (1, 2) and/or connector means (3) and/or the tension element (8) is made of a polymer material, preferably a thermoplasticly processable plastic.

12. A covering device, preferably for the subsequent insulation of the connection location of pipes, including at least two cover shells (1, 2) which surround the pipes in their assembled condition, further characterized in that the covering device has at least one sealing element (14) which in assembled condition is arranged between the covering device and a pipe and surrounds the pipe.

13. A covering device according to claim 12, further characterized in that the sealing element (14) is designed as a sealing ring (15).

14. A covering device according to claim 12, further characterized in that the sealing element (14) at least one location along its circumference is broken through itself.

15. A covering device according to claim 12, further characterized that the sealing element (14) has at least one weakened breakage location.

16. A covering device according to claim 12, further characterized in that the sealing element (14) has at least two concentric rings.

17. A covering device according to claim 12, further characterized in that the sealing element (14) on its inner wall and/or on its outer wall has rib shaped projections (16).

18. A covering device according to claim 12, further characterized in that the sealing element (14) in assembled condition is form fittingly connected with the cover shells (1, 2).

19. A covering device according to claim 12, further characterized in that the sealing element (12) is made of a polymer material, preferably an elastomer or a thermoplastic elastomer.
